(19) United States
(12) Patent Application Publication
(10) Pub. No.: US 2004/0004361 A1
(43) Pub. Date: Jan. 8, 2004

(54) Scoop & seal

(76) Inventors: Karen Lynn Foster, Newark, DE (US); Evelyn Marie Wyatt, Clayton, DE (US)

Correspondence Address: KAREN L. FOSTER, 204 North Dillwyn Rd. Windy Hills, Newark, DE, 19711, US

(21) Appl. No.: 10/189,605

(22) Filed: Jul. 5, 2002

(51) Int. Cl. A01K 29/00

(52) U.S. Cl. 294/1.4

(57) ABSTRACT

Scoop & Seal is heat sensored containing unit for animal waste. It's primary function is to pick-up animal waste in a safe and sanitary way, using a heating element to seal the plastic bag after the animal waste is put into the container. Scoop & Seal is disclosed having plastic bags in container box and on scooper shovel, and a heat sensored strip to seal container bag closed in the container box. The heat sensor button is located at top of handle with wire running down the handle, to the heat strip in container box. Scooper trigger handle release is located directly under handle, having a pully to activate the scooper arm into the container box. Pulley string runs down scooper rod from trigger release to scooper trigger arm. Spring loaded clamps in container box holds plastic bag down while heat strip seals bag. Flip top container box for roll of plastic bags in located at back of waste container box. Bags are pulled through waste container box, and handles on the bag are folded back over container box. Open cone shaped compartment is located on back side of scooper rod to hold bags for scooper shovel.

This application is for a containing unit for animal waste, with it's primary function to pick up animal waste in a safe and sanitary way, using a heating element to seal the plastic bag after the animal waste is put into the container.

### BACKGROUND OF THE INVENTION

1. Field of the Invention

The invention herein resides in the field of electrically powered scoopers and particularly relates to scoopers with battery operated trigger, to operate heat strips in waste container box, from button on handle, with plastic bags to seal the waste and pulley string to bring scooper shovel with plastic bag covering it, into waste container box, operated by trigger on handle and spring loaded clamps to hold down bags.

2. History of Prior Art

Scoopers are normally built with scooper rod container at base, and a scooper shovel. To operate this unit a person scoops the waste with a shovel and puts it into the container. After using this scooper a person must clean the unit and dispose of the animal waste. With this type of scooper you are exposed to unsanitary conditions and contact with animal waste. After disposing of the unsealed waste, it then contaminates trash container and has lingering odors.

### SUMMARY OF THE INVENTION

It is an object of the present invention to provide an electric battery-powered scooper that has an easy-to-use and highly efficient mode of operation.

It is a further object of the invention to provide an electric battery-powered scooper with a self-sealing bag and thereby producing sanitary disposal of animal waste.

As a person depresses the trigger handle release, causing the pulley to pull upward, this allows the trigger arm with the scooper shovel to pull upward, allowing waste to be collected in shovel, and when trigger handle is released it forces the shovel into waste container.

When pressing battery operated heat sensor button, electricity is sent down wire to heat sensor strips in waste container box and triggering spring loaded damp to dose on plastic bags, causing large bag in waste container to seal with small bag from scooper shovel to seal closed. The large waste container bag is then pulled out and thrown away with no human contact with waste, or no need to clean container. The small bag found in the cone shaped compartment on scooper rod, is placed on shovel and the next large bag, found on back of waste container box is pulled through waste container box and folded back for the next time to be used.

### BRIEF DESCRIPTION OF DRAWINGS

FIG. 1 illustrates a perspective view of the electrically battery-powered Scoop & Seal of this invention.

### DESCRIPTION OF THE PREFERRED EMBODIMENTS

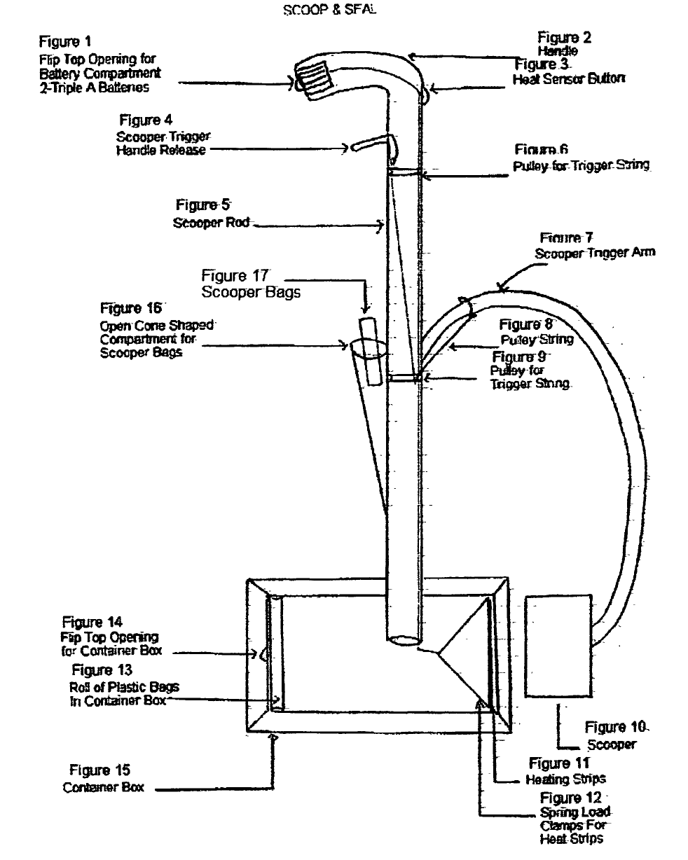

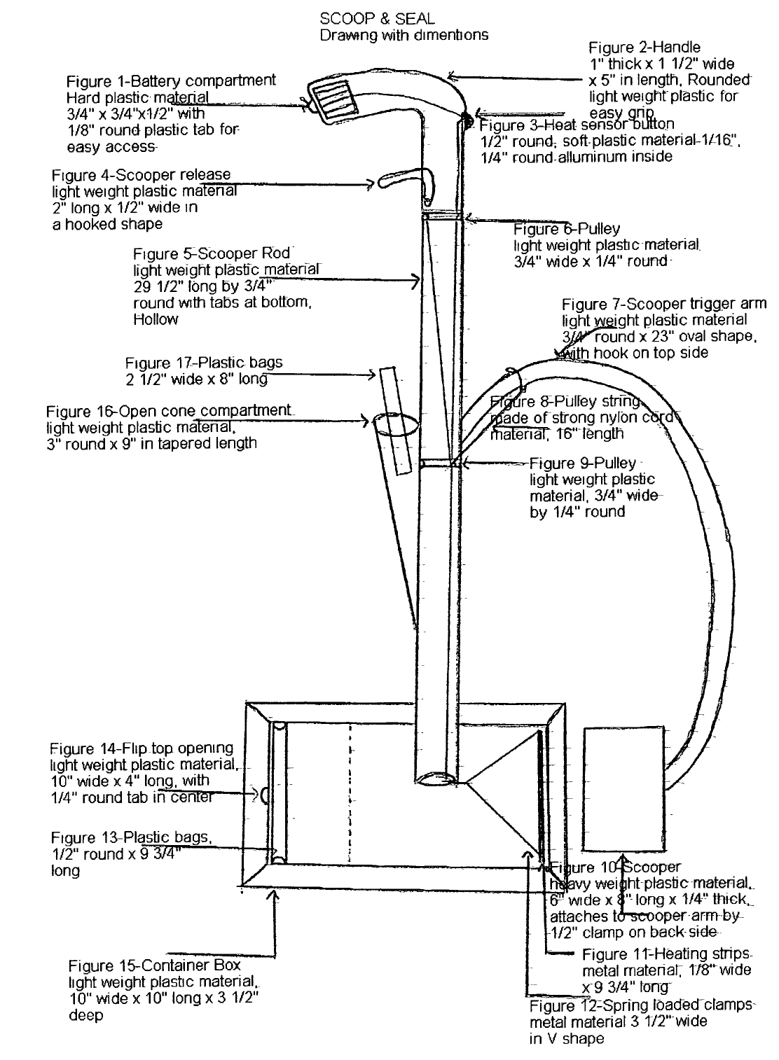

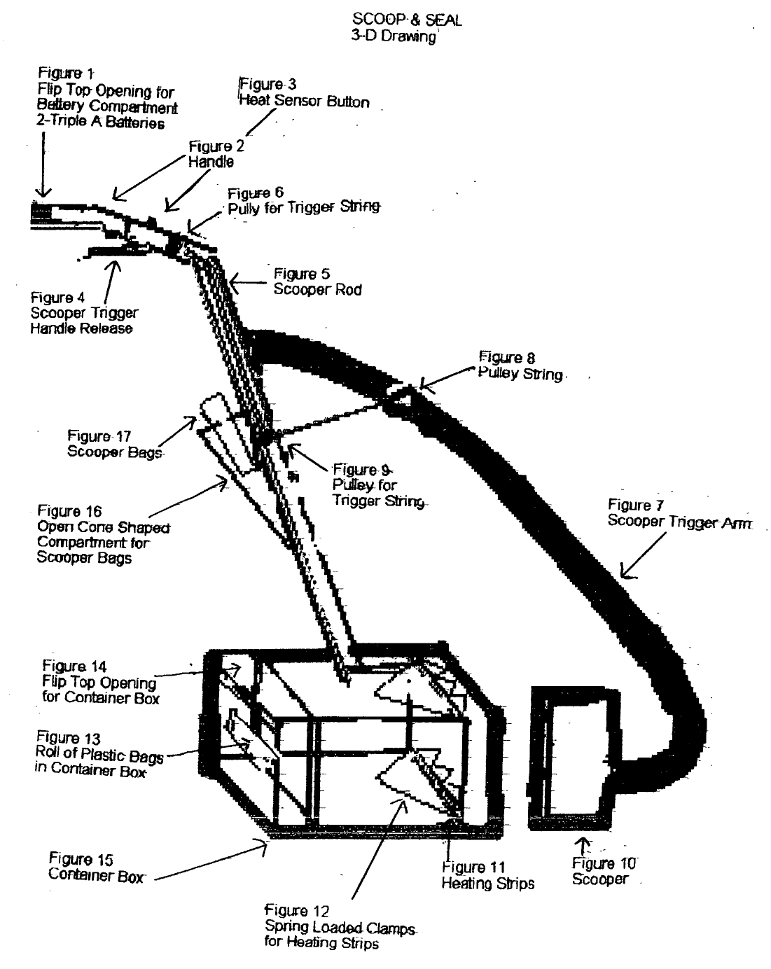

FIG. 1 illustrates a perspective view of Scoop & Seal, #5 is plastic rod with handle, attached to rod is #1 flip top opening for battery compartment, holding two triple A batteries. Attached to the rod is #3 heat sensor button with wire connected to battery compartment #1 and #3 heat sensor button, running down rod #5 to heating strip in container box #11. Attached to the rod is #4 handle release with pully #6 running down to base of #7 trigger arm. Pulley is attached to #7 trigger arm allowing arm to be pulled upward. Trigger arm #7 has scooper shovel attached at base #10, by pressing handle release #4, pulley string #6 pulls up trigger arm #7 and scooper shovel #10 comes upward, and when #4 handle release is released #10 scooper shovel go's into #15 waste container box. Connected to #5 rod, at the base of this rod is waste container box #15. Attached to waste container box #15 is #14 plastic flip top conatiner box that holds #13 roll of plastic bags. Front of waste container box #15 is spring load clamps to close bag #13 after bags #13 are pulled through #15 waste container box and folded back over #15 waste container box on outside of box. Open cone shaped compartment for small scooper bags #16 roll of small plastic bags #17, they go over #10 scooper shovel.

The present invention represents a significant advance over prior scoopers. Scoop & Seal is a heat sensored containing unit for animal waste. It's primary function is to pick-up animal waste in a safe and sanitary way, using a heating element #11 to seal the plastic bag #13, after the animal waste is put into the waste container box #15. Light weight plastic makes it easy to hold and carry around. Trigger handle release #4 with pulley #6 and #8, makes it easy to scoop waste into scooper shovel #10 with small plastic bag #17 covering shovel #10. No human contact of the animal waste is needed making it not only safe but sanitary as well. No cleaning of scooper after use and no contamination of trash containers or lingering odors, when thrown away. Helps the environment from contamination of animal waste on ground, trash containers and transmitting of parasites to humans and other animals.

Although the present invention has been described with reference to particular embodiments, it will be apparent to those skilled in the art that variations and modifications can be substituted therefor without departing from the principles and spirit of the invention.

What we claim as our invention is:

1. Scoop & Seal is a type having a heat sensored containing unit for animal waste, it's primary function is to pick-up animal waste in a safe and sanitary way, using a heating element to seal the plastic bag after the animal waste is put into the container; said made of light weight plastic; said flip top battery compartment at top of handle holding two triple A batteries; said wire running down and inside handle to heat strips in waste container box; said heat sensor button on handle to activate heating strips; said scooper trigger handle release to activate scooper trigger arm; said pulley string running down and inside scooper rod from trigger handle to trigger arm; said flexible trigger arm with scooper shovel; said open cone shaped compartment for scooper shovel on back side and midway down scooper rod; said plastic bags go over scooper shovel; said container box at bottom of scooper rod to contain waste; said flip top container box for roll of plastic bags at back of waste container box; said plastic bags are pulled through waste container box and folded back over waste container box; said heat strips in waste container box for sealing of plastic bag; said spring loaded damps to hold down plastic bags for sealing of heat strips.
